(19) United States
(12) Patent Application Publication
(10) Pub. No.: US 2022/0323804 A1
(43) Pub. Date: Oct. 13, 2022

(54) A FIRE RESISTANT CABINET

(71) Applicant: IWI Technology II ApS, Kgs. Lyngby (DK)

(72) Inventor: Lars Forsberg, Kgs. Lyngby (DK)

(21) Appl. No.: 17/612,946

(22) PCT Filed: May 20, 2020
(86) PCT No.: PCT/EP2020/064147

§ 371 Date: Nov. 19, 2021

(30) Foreign Application Priority Data
May 23, 2019 (DK) PA 2019 70327

(51) Int. Cl. A62C 3/06; A47K 5/12

(52) U.S. Cl. CPC A62C 3/065; A47K 5/12

(57) ABSTRACT

A fire resistant cabinet has a housing delimiting an interior space for accommodating a sanitizer container holding a flammable liquid. The wall of the housing comprises at least one exterior shell part made of at least one material selected from the group consisting of melamine resin, corian or fiber-reinforced concrete.

### CROSS REFERENCE TO RELATED APPLICATIONS

This application is a 371 filing of International Patent Application PCT/EP2020/064147 filed May 20, 2020, which claims the benefit of priority to Danish patent application no. PA 2019 70327 filed May 23, 2019, the disclosures of which are hereby incorporated by reference herein.

### TECHNICAL FIELD

The present invention relates to a fire resistant cabinet having a housing delimiting an interior space adapted for accommodating a sanitizer container that holds a sanitizer in form of a flammable liquid and has an associated dispenser means, whereby the sanitizer container is adapted to dispense the flammable liquid, that said wall of the housing comprises at least one exterior shell part, wherein said at least one exterior shell part is composed of an exterior front wall panel, an exterior bottom wall panel, an exterior top wall panel, and two exterior side wall panels.

### BACKGROUND

Chinese patent document CN 107 661 051 relates to a horizontal box storage drawer assembly having walls partly made of melamine resin.

Japanese patent documents JP 2019 037058 discloses a vertil wiring box in which a melamine resin can be added to the wall material composition.

Japanese patent documents JP H02 136 486 discloses a closed cupboard having melamine resin added to a protective layer on the wall structure to prevent fire from getting access to a substrate structure for said substrate.

None of CN 107 661 051, JP 2019 037058 and concerns storing a dispenser of flammable liquid so that the dispenser is able to dispense a dose of flammable liquid.

Alcohol-based hand sanitizers are recommended for use by the World Health Organization (WHO) to help prevent the spread of infection. Alcohol-based hand sanitizers typically contain between 60%-85% (v/v) alcohol in order to effectively kill germs.

There are many safety standards and rules to follow when using alcohol-based hand sanitizers. E.g. fire code regulations require such alcohol-based hand sanitizers to be classified as containing flammable liquids. Also, dispensers for alcohol-based hand sanitizers must not be installed directly adjacent to, directly above, or below an electrical receptacle, switch, appliance, device, or other ignition source. The acceptable distance is about 15 cm from the center line of the dispenser to the ignition source. Also there are limits for how much a single alcohol-based hand sanitizer dispenser much contain, and how many such dispensers that are allowed in the control area of the building, thus in space within a building where quantities of hazardous materials not exceeding the maximum allowable quantities per control area are stored, dispensed, used and handled.

Due to these precautions, regulations and risks there is a need within the art for improvements and precautionary means relating to hand sanitizer dispensers using flammable liquids.

### SUMMARY OF THE INVENTION

It is a first aspect of the present invention to provide a fire resistant cabinet of the kind mentioned in the opening paragraph that comply with ISO standard no. 834.

It is a second aspect of the present invention to provide a fire resistant cabinet of the kind mentioned in the opening paragraph that can keep the sanitizer container, e.g. holding an alcohol-based hand sanitizer, intact in case of fire and when exposed to high temperatures.

It is a third aspect of the present invention to provide a robust fire resistant cabinet of the kind mentioned in the opening paragraph that can resist impacts and similar external forces.

It is a fourth aspect of the present invention to provide a fire resistant cabinet of the kind mentioned in the opening paragraph that does not leak sanitizer.

The novel and unique whereby these and other aspects are achieved by the present invention consists in that the wall of the housing comprises at least one exterior shell part made of at least one material selected from the group consisting of melamine resin, corian or fiber-reinforced concrete, and keeps the temperature of the sanitizer in the sanitizer container below the boiling point of 78° C. when heated to fire temperatures, wherein the exterior bottom wall panel has a cabinet outlet via which the flammable liquid is dispensed.

Melamine resins are hard, very durable, and versatile thermosetting aminoplast with good fire and heat resistance properties. Melamine resins can be molded to make products of desired shape. Suitable melamine resins are e.g. known under the trademarks Saduren®, Maprenal®, Meldur®, Resimene®, Leaf®, and E-Gen®. This list should not be construed at exhaustive nor as limiting the scope of useable melamine resins.

Corian is the product of acrylic polymer and alumina trihydrate originally invented by DuPont. Corian is non-porous, thermoformable, and can be given seamless appearance, so that the fire resistant cabinet can be formed into generally any shape when using Corian. Corian is heat resistant up to 100° C. A corian housing ca e.g. be generally tubular, have a flat back wall and an exterior shell part in form of half-shell front wall part. In an alternative embodiment individual wall parts can be joined by adhesive, and optionally after the adhesive has dried, the area is sanded and polished to create a seamless joint.

Fiber reinforced concrete (FRC) is yet an alternative material for manufacturing the exterior shell part. Fiber reinforced concretes are more durable than normal concrete. The fibers can be steel fiber or plastic fibers of e.g. polypropylene and vinyl.

Like Corian fiber reinforced concrete can be given substantially any shape in the molding process, so that the exterior shell part of the housing can be made with minimum joints.

The access opening to the interior of the exterior shell part can easily be closed and covered by a backing component fastened to said exterior shell part. Preferably the backing component is made of same or different material as the exterior shell part. Preferably the backing component is made of a material having fire resistant properties.

Typically, the exterior shell part is pivotally connected to the backing component to allow access to arrangement the sanitizer container and dispenser means properly inside the housing. The backing component may serve for suspending the fire resistant cabinet to e.g. a wall. In the event that the suspension surface for the fire resistant cabinet in itself is fire-proofed, the sanitizer container with associated dispenser means, such as a sensor and an actuator mechanism to trigger dispensing a dose of sanitizer, and/or a suspension means for keeping the sanitizer container in upright position, can be suspended directly on said suspension surface and then covered by the exterior shell part, e.g. by using detachable coupling means, such as male/female coupling means, snap fitting means, screws, etc.

The wall of the housing may further comprise at least one interior shell part made of same or different material as the at least one exterior shell part.

The interior shell part can fit inside the exterior shell part, optionally so that the interior shell part lines an interior surface of the exterior shell part, so that the free space inside the housing remains as large as possible.

Accordingly, the housing can have just a single shell part in form of the exterior shell part, but the wall can also have several layers, such as a double wall in case the interior shell part lines more or less of the interior surface of the exterior shell part. The interior shell part can e.g. be made of metal, such as steel, to provide further structural integrity, support, and provide support for securing of components for holding e.g. the sanitizer container in the correct position inside the housing and for securing of the associated actuator mechanism for the dispensing action.

In an inexpensive embodiment the interior shell part can simply be provided by one or more single or curved metal plates, screwed, glued or otherwise secured to or joined with the exterior shell part.

To improve insulation and fire resistance even more the interior shell part can be provided with a layer of aerogel. Additionally, or alternatively an aerogel layer can also be disposed between the interior shell part and the exterior shell part.

Aerogel insulation is up to five times more effective than traditional insulation. Aerogel is available in rolls or fabricated pieces for cryogenic, ambient and high temperature applications. E.g. Pyrogel®, that can be obtained from Pacor, Inc, 333 Rising Sun Road, Bordentown, N.J. 08505, has a density of 0.17 kg/L and an operating temperature of 0° C. to 200° C. It comes in endless webs having e.g. a thickness of 2 mm and a width of about 1.5 m and is easily customized and dimensioned for a certain purpose. Preferably the aerogel layer is at least 2 mm thick, e.g. at least 3 mm.

Any of the interior shell part, the exterior shell part and the aerogel layer can be laminated together by means of chemical fasteners, such as glues, or can be secured to each other by means of mechanical fastener, such as bolts or screws.

To dispense the sanitizer, such as an alcohol-based hand sanitizer contained in a sanitizer container, that are placed in the protected environment inside the housing of the fire resistant cabinet. The cabinet outlet may be provided with a thermal safety component adapted to close the cabinet outlet in response to elevated temperatures.

To this purpose the cabinet outlet and/or the thermal safety component may additionally be provided with a fire-retardant sealing means, in particular to prevent heat and fire to enter the housing via the cabinet outlet and the thermal safety component. Preferably said fire-retardant sealing means can include one or more of the fire-retardant sealing means selected from the group comprising an intumescent material such as fire-retardant paste or fire-retardant gel, and aerogel.

Once an actuator mechanism is actuated, e.g. when a user triggers an optical sensor to emit a signal, sanitizer can be guided through out of the dispensing outlet of the sanitizer container, and out of the fire resistant cabinet via the thermal safety component in the cabinet outlet and onto e.g. the hands of the user. As long as the temperature in the environment surrounding the fire resistant cabinet is below a threshold value given by the thermal safety component, the sanitizer can pass through said thermal safety component. In the event the environmental temperature exceeds the threshold value the thermal safety component plugs the cabinet outlet so that sanitizer can no longer get out of the cabinet. The thermal safety component may be coupled to a switch that also deactivates the actuator mechanism if the thermal safety component is caused to plug the cabinet outlet.

The housing may comprises at least the exterior shell part, which is composed of an exterior front wall panel, an exterior bottom wall panel, an exterior top wall panel, and two exterior side wall panels, and optionally one or more of the backing component and the interior shell part, which interior shell part is composed of an interior front wall panel, an interior bottom wall panel, an interior top wall panel, two interior side wall panels, wherein said wall panels can be separate wall panels joined along their respective adjacent edges by gluing, welding, fusing, laying-up or mechanical fasteners, or said wall panels can be obtained by making the respective shell part and/or the housing as an integral unit, e.g. by molding and/or shaping.

In a simple embodiment the housing may comprise only the exterior shell part, which is composed of a front wall panel, the bottom wall panel, a top wall panel, two side wall panels, and optionally the backing component.

If the wall panels are separate parts these can then easily be joined along their respective adjacent edges by gluing, welding, fusing, laying-up or mechanical fasteners. In the alternative said wall panels are obtained by making the housing as an integral unit, e.g. by molding and/or shaping.

### BRIEF DESCRIPTION OF THE DRAWINGS

The invention will now be explained in further detail with references to the accompanying drawing in which

FIG. 1 shows, in perspective slightly from below, an oblique front view of an embodiment of a fire resistant cabinet,

FIG. 2 shows the same from the backing component,

FIG. 3 is a perspective exploded view of a fire resistant cabinet,

FIG. 4 is an exploded side view of the same,

FIG. 5 shows, in an enlarged scale view, the lower part of the fire resistant cabinet with detached backing component and the actuating mechanism for dispensing a dose of sanitizer removed for improved visually,

FIG. 6 is a perspective view of a fire-retardant thermal safety component for being arranged in the cabinet outlet, and

FIG. 7 is a sectional view taken along line VII-VII in FIG. 6.

### DETAILED DESCRIPTION OF THE INVENTION

It is emphasized that the size and shape of the components shown in the figures are not to be construed as limiting and exhaustive. Within the scope of the present invention the exterior shape of the fire resistant cabinet can quite as well be any other than the shown box, including but limited to tubular, in which case the wall of the housing may be composed of two identical or similar tube halves that are assembled, e.g. snapped together. In such an embodiment the fire resistant cabinet can be free-standing, thus not needing a backing component. The two tube halves can be held detachable but firmly together using e.g. an exterior fire resistant band or be snapped together as described above.

The sanitizer container need not be bottle-shaped but can have any kind, including pouches. The suspension means for the sanitizer container is simple selected accordingly and any kind of suspension means can be fitted inside the housing.

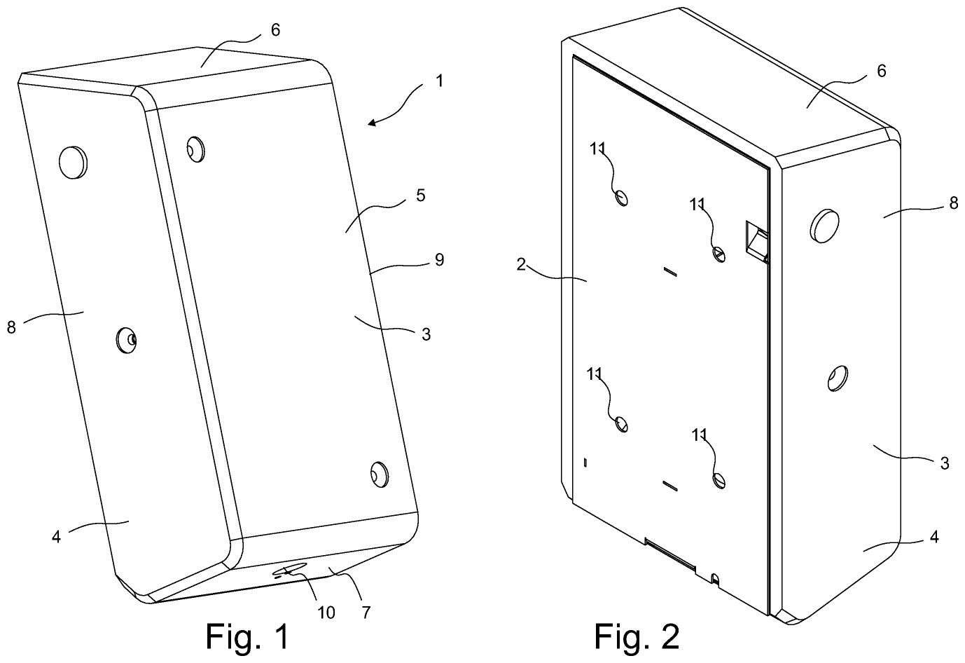

FIG. 1 shows, in perspective slightly from below, an oblique front view of a box-shaped embodiment of a fire resistant cabinet 1. FIG. 2 shows the same from the backing component 2.

For simplicity the fire resistant cabinet 1 will in the following only be denoted the cabinet 1.

The cabinet has an exterior shell part 3 delimited by a wall 4. The wall is composed of an exterior front wall panel 5, an exterior top wall panel 6, an exterior bottom wall panel 7, and two opposite exterior side wall panels 8,9. The exterior wall panels are joined along adjacent edges to obtain the box-shape. The exterior bottom wall panel 7 has a cabinet outlet 10.

The backing component 2 has four mounting holes 11 for suspending the cabinet 1 to a wall (not shown).

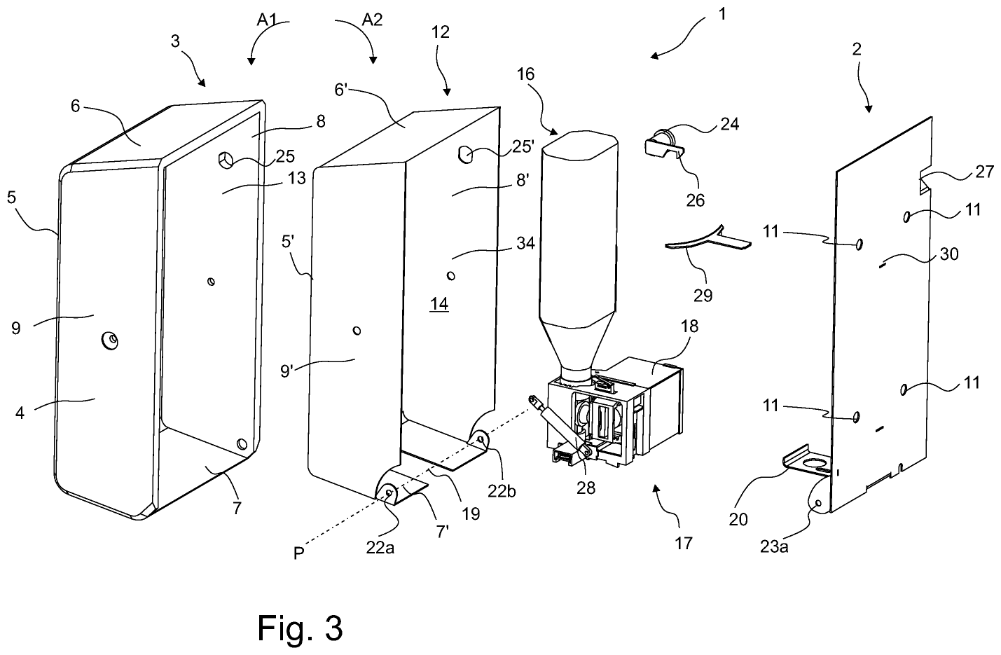

The interior structure of the cabinet 1 is shown in more details in the exploded perspective view of FIG. 3.

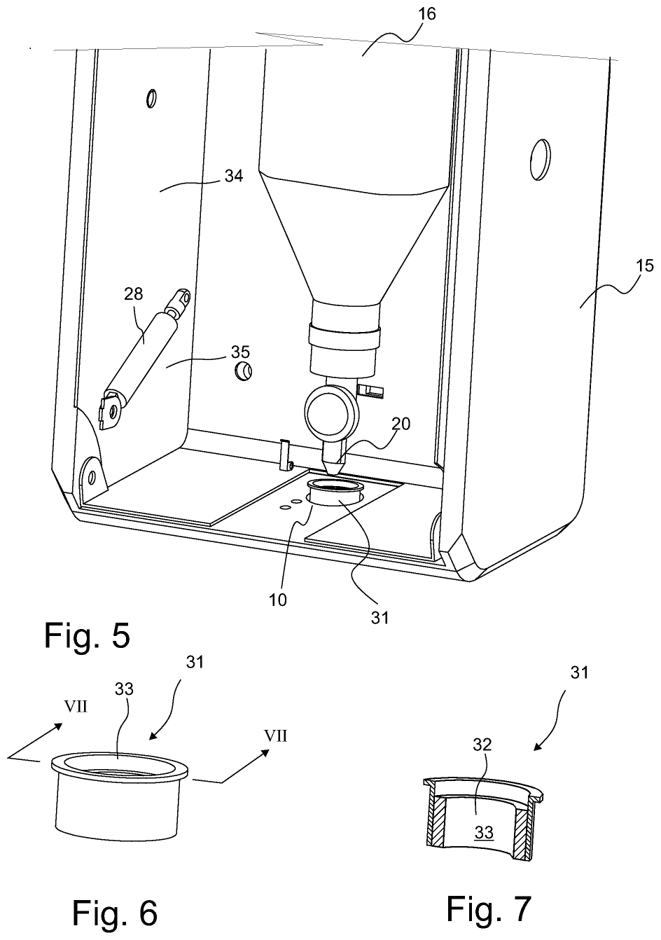

FIG. 3 further shows that the interior shell part 12 has an interior front wall panel 5′, an interior top wall panel 6′, an interior bottom wall panel 7′, and two opposite interior side wall panels 8′, 9′, which provide the interior shell part 12 with substantially the same shape as the exterior shell part 3. In such a configuration said interior shell part 12 can closely line at least some of the interior face 13 of said exterior shell part 3, thereby preserving as much space 14 as possible inside the combined housing 15, as also seen in FIG. 5, for the sanitizer container 16, the actuating mechanism 17 for dispensing a dose of sanitizer from the sanitizer container 16.

The actuating mechanism 17 can be any conventional type including e.g. a motor 18, and an optical sensor (not shown) to be actuated from below the bottom wall panel 7. The optical sensor delivers a signal to start the motor 18 to conduct a dispensing sequence and appropriate switches serve to control the dispensing sequence and thus the amount of dispensed sanitizer. Such actuating mechanisms are known to the person skilled in the art and will not be described in further details.

The interior bottom wall panel 7′ has a slot 19 that allows the dispensing outlet 20, as seen best in FIG. 5, to dispense sanitizer via the cabinet outlet 10. A protruding tongue 21 on the backing component 2 serves as a suspension means for the sanitizer container, the bottle 16. The protruding tongue 21 fits inside and/or above the slot 19 to guide the dispensing outlet 20 of the sanitizer container 16 in alignment with the cabinet outlet 10.

The interior shell part 12 has first pivot means 22a, 22b, such as first pivot bearings, that extend upright from the interior bottom wall panel 7′ in substantial the same plane as the two opposite interior side wall panels 8′, 9′. The backing component 2 has second pivot means 23a, 23b, such as second pivot bearings, to be coupled to the first pivot means 22a, 22b for allowing the combined interior shell part 12 and exterior shell part 3 to pivot free of the backing component 2 to e.g. replace an empty sanitizer container 16 with a new one, to conduct maintenance, etc. In case the housing is a simple structure without interior shell part, first pivot means can be arranged on the exterior shell part.

The first pivot means 22a, 22b and the second pivot means 23a, 23b can be pivotally connected by means of respective pivot pins (not shown), whereby the combined exterior shell part 3 and interior shell part 12, that together with the backing component 2 constitute the housing 15 of the present embodiment of a cabinet 1, can be pivoted in relation to the backing component 2 along a pivot axis P substantial parallel to the bottom wall parts 7, 7′.

In case the combined exterior shell part 3 and interior shell part 12 are to be pivoted a slam lock button 24 mounted in aligned slam lock holes 25, 25′ of the respective shell parts 3,12 are pressed inside slam lock holes 25, 25′ to release a first slam hook 26 of the slam lock button 24 from a second slam hook 27 of the backing component 2, whereby the combined exterior shell part 3 and interior shell part 12 can be swung free of the backing component 2, as indicated by the curved arrow A1, under the control of a piston member 28. In order to close the combined exterior shell part 3 and interior shell part 12 against the backing component 2 again the combined exterior shell part 3 and interior shell part 12 are simply pushed back in the direction towards the backing component 2, as indicated by curved arrow A2, until the first slam hook 26 and the second slam hook 27 snaps together, which action can be both tactile and audible. The piston member 28 is secured at one end to the interior surface of the interior side wall part 9 and the other end is secured to the backing component 2 in the vicinity of the second pivot means 23a. A corresponding optional second piston can be secured similarly at one end to the interior surface of the interior side wall part 8 and with the other end secured to the backing component 2 in the vicinity of the second pivot means 23b, thus on the opposite side of the housing 15. It should be noted that any means that can serve to assist in controlling the opening and closing of the cabinet can be implemented in addition to or as an alternative to the piston. Such means can e.g. be a simple spring, and such means can be automatic, and controlled by the motor as well.

It should be noted that in case the cabinet 1 is to be mounted on a fire-proofed surface no backing component 2 is needed and the housing 15 is constituted by the combined shell parts 3,12.

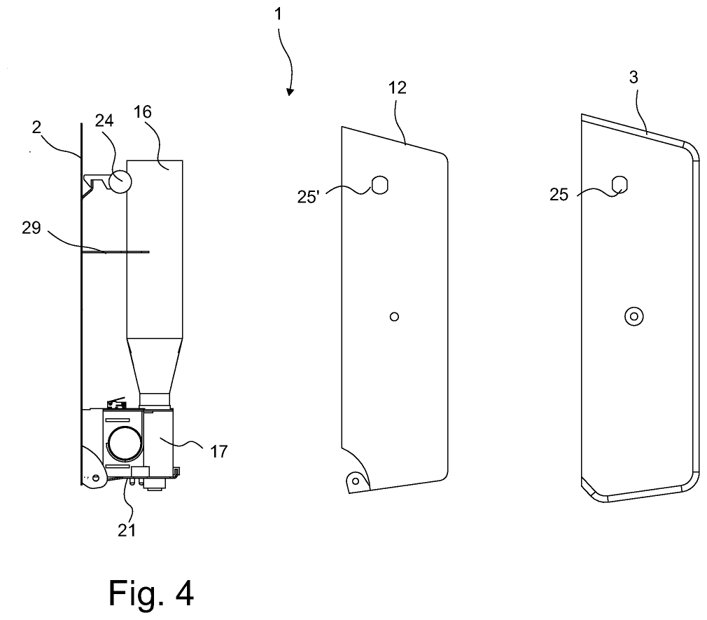

A holder 29 for keeping the sanitizer container 16 in upright position is attached to the backing component 2, as seen best in the exploded side view of FIGS. 3 and 4, e.g. via slot 30. The holder 29 is part of the suspension means for the sanitizer container 16.

FIG. 5 is a fragmentary, enlarged scale view inside the lower part of the fire resistant cabinet 1 with detached backing component 2, and where the actuating mechanism 17 for dispensing a dose of sanitizer has been removed for improved visually of the thermal safety component 31 that is inserted in the cabinet outlet 10 in alignment with the dispensing outlet of the sanitizer container 16.

The thermal safety component 31 is seen further enlarged and in perspective in FIG. 6. The thermal safety component 31 fits sealingly into the cabinet outlet 10 as a plug. And to further make the thermal safety component 31 fireproof and preventing heat and flames getting up through the thermal safety component 31, said thermal safety component 31 may have an interior lining 32 of fire resistant material, as shown in the sectional view of FIG. 7. In the event of overheating the fire resistant material will swell and close the opening 33 of the thermal safety component.

More or less of the interior surface 34 of the interior shell part can have a layer 35 of aerogel (not shown).

1-11. (canceled)

12. A fire resistant cabinet having a housing wherein a wall of the housing delimits an interior space, which accommodates a sanitizer container that holds a sanitizer in form of a flammable liquid and has an associated dispenser means, whereby the sanitizer container is adapted to dispense the flammable liquid, that said wall of the housing comprises at least one exterior shell part, wherein said at least one exterior shell part is composed of an exterior front wall panel, an exterior bottom wall panel, an exterior top wall panel, and two exterior side wall panels, wherein said at least one exterior shell part is made of at least one material selected from the group consisting of melamine resin, corian or fiber-reinforced concrete and keeps the temperature of the sanitizer in the sanitizer container below the boiling point of 78° C. when heated to fire temperatures, wherein the exterior bottom wall panel has a cabinet outlet via which the flammable liquid is dispensed.

13. A fire resistant cabinet according to claim 12, wherein the wall of the housing further comprises at least one interior shell part made of same or different material as the at least one exterior shell part.

14. A fire resistant cabinet according to claim 12, wherein the interior shell part fits inside the exterior shell part.

15. A fire resistant cabinet according to claim 12, wherein the exterior shell part is pivotally connected to a backing component.

16. A fire resistant cabinet according to claim 13, wherein an actuator mechanism for actuating dispensing of a sanitizer from the sanitizer container and/or a suspension means for keeping the sanitizer container in upright position is/are suspended to one or more of the interior shell part and the exterior shell part.

17. A fire resistant cabinet according to claim 13, wherein the interior shell part has a layer of aerogel.

18. A fire resistant cabinet according to claim 17, wherein any of the interior shell part, the exterior shell part and the aerogel layer are laminated together by means of chemical fasteners, such as glues, or are secured to each other by means of mechanical fastener, such as bolts or screws.

19. A fire resistant cabinet according to claim 12, wherein the cabinet outlet is provided with a thermal safety component.

20. A fire resistant cabinet according to claim 12, wherein the cabinet outlet and/or the thermal safety component has a fire-retardant sealing means.

21. A fire resistant cabinet according to claim 12, wherein the housing comprises one or more of the backing component and the interior shell part, which interior shell part is composed of an interior front wall panel, an interior bottom wall panel, an interior top wall panel, and two interior side wall panels, wherein said wall panels are separate wall panels joined along their respective adjacent edges by gluing, welding, fusing, laying-up or mechanical fasteners, or said wall panels are obtained by making the respective shell part and/or the housing as an integral unit, e.g. by molding and/or shaping.

22. A fire resistant cabinet according to claim 12, wherein the housing comprises at least the exterior shell part, which is composed of the exterior front wall panel, the exterior bottom wall panel, the exterior top wall panel, and the two exterior side wall panels, and the backing component, wherein said wall panels are separate wall panels joined along their respective adjacent edges by gluing, welding, fusing, laying-up or mechanical fasteners, or said wall panels are obtained by making the respective shell part and/or the housing as an integral unit, e.g. by molding and/or shaping.
